(19) United States
(12) Patent Application Publication
(10) Pub. No.: US 2026/0212633 A1
(43) Pub. Date: Jul. 23, 2026

(54) METHOD FOR OBJECT SIZE DETECTION IN A WASTE PIT

(71) Applicant: KANADEVIA INOVA AG, Zürich (CH)

(72) Inventors: Miriam Estefânia RODRIGUES FERNANDES RABAÇAL, Zurich (CH); Nora MORENO CHEHDA, Kloten (CH)

(21) Appl. No.: 19/133,495

(22) PCT Filed: Nov. 28, 2023
(86) PCT No.: PCT/EP2023/083297

§ 371 Date: May 28, 2025

(30) Foreign Application Priority Data
Nov. 29, 2022 (EP) 22210275.8

(51) Int. Cl. G06V 10/26; G06V 10/766; G06V 10/82

(52) U.S. Cl. CPC G06V 10/26; G06V 10/766; G06V 10/82; G06V 2201/06

(57) ABSTRACT

Method for object detection based on size in the waste pit of a waste treatment plant comprising the steps of: a) Collecting an image of waste in a waste pit of a waste treatment plant using a camera and transferring the image to a data processing unit; b) Identifying an individual object in the image using an algorithm for segmentation; c) Determining the size of the identified individual object; d) Comparing the size of the identified individual waste object with a threshold value and; e) Classifying whether the object is a bulky waste object or not.

The present invention relates to a method for object detection based on size in the waste pit of a waste treatment plant.

Waste is a reliable and important source of energy in the modern world. The thermal treatment of waste allows to reduce environmental problems related to the deposition of waste in waste landfills. Thermal treatment of waste is usually performed in a waste treatment plant which comprises a waste pit and a waste boiler. Since the waste boiler has a size limit for objects that can be treated, it is important to detect and isolate objects that are above the specific size limit. Such objects are also known as “bulky waste objects”. Typical bulky objects are mattresses, metal pipes, supermarket shopping trolleys, palm tree trunks or rubbish bins.

Bulky waste objects can cause blockages in the treatment plant and lead to unplanned shutdowns. These shutdowns can lead to costs of up to 100,000€ per single plant due to lost production capacity. Additionally, the blocking bulky objects have to be removed, which creates a health and safety risk for the operating personal and often requires the repair or the restart of the plant.

In a Commonly Used Manual Approach These Bulky Waste Objects are detected by one or more operators, which often simultaneously monitor up to 8 screens or visually inspect the bunker and label the bulky objects. To reduce the operator's workload automatic object detectors have been developed.

WO 2022185340 A1 discloses a material detector to identify waste comprising a sensor, a detection unit and a comparison unit. The sensor captures data from the outermost layer of the waste and the detection unit determines one or more identity parameters of the waste material. The detection unit derives a digital fingerprint based on at least one physical parameter and/or chemical parameter extracted from the data, and compares the digital fingerprint with predefined detectable physical parameters and/or chemical parameter of the outermost layer stored in a product database. The comparison unit then labels the waste object based on the fingerprint and a relationship table that links the waste object to an entry in the product database. This approach requires a database of all possible waste objects and also their fragments, since the waste can be delivered also in parts. Hence, an immense work is required to produce and update this database to keep the detection of waste working.

US 2022/270238 A1 discloses a system, device, process and method of measuring food, food consumption and waste with image recognition. The system allows to measure, classify, identify and/or record food, food consumption and food waste and to enable service providers, consumers, and other parties to assess food consumption and waste over a period of time.

It is therefore an object of the present invention to provide a method for object detection based on size in the waste pit of a waste treatment plant that enables an improved rate of detection of bulky waste objects.

This object is achieved by the method of the present invention as defined in claim 1 and a device of the present invention as defined in claim 11. Preferred embodiments are subject of the dependent claims.

In accordance with claim 1, the present invention refers to a method for object detection based on size in the waste pit of a waste treatment plant comprising the steps of:
a) Collecting an image of waste in a waste pit of a waste treatment plant using a camera and transferring the image to a data processing unit;
b) Identifying an individual object in the image using an algorithm for segmentation;
c) Determining the size of the identified individual object;
d) Comparing the size of the identified individual object with a threshold value; and
e) Classifying whether the object is a bulky waste object or not.

In the context of the present invention the term “waste pit” is used to describe the bunker of a waste treatment plant, including the side walls and possible openings such as gates at the side walls.

In the context of the present invention the term “segment” refers to an output feature of the segmentation algorithm. The collected image is processed by the segmentation algorithm, which creates (assigns) at least one segment of each object that is identified in an image. In the following, the term “segment” and “object” may thus be used interchangeably.

Thanks to the use of an algorithm for segmentation, the method of the present invention has the advantage that the time-Consuming consuming preparation of a database for training is not required, since the inventive methods allows a determination of the object size independent of the object type or material. In other words, the inventive method does not aim at identifying the type or nature of a waste object (e. g. “chair”, “mattress”, “plastic box” or “piece of wood”) but merely aims to determine whether its size is above or below a given threshold value. This reduction in information enables an efficient approach to identify bulky waste objects. It is therefore neither a problem to identify bulky waste objects if a waste object is broken or if there is only part of a specific object left, as long as the visible part or the broken piece of the original object is above the threshold value. This is a huge advantage because, unlike other prior art object detection techniques, there is no need of increasing the complexity of the algorithm to enable a detection of partly covered objects. Also, the threshold value can be set based on the size limit of an individual waste treatment plant.

In line with the inventive method, step a) involves collecting an image, which also covers the collection of multiple images or image series.

For the method of the present invention, it was surprisingly found that despite the reduction in information that needs to be processed or steps that need to be performed, the rate of detection of bulky waste objects could be significantly improved compared with the methods of the known art. The method of the present invention was also able to detect an object in the process of falling into the waste pit in contrast to other prior art object detection techniques that are limited to detect waste objects stored in a waste pit. Furthermore, the method of the present invention can also be used in a waste treatment plant where waste is provided from a delivery truck via a ramp or a conveyor belt to the waste pit.

In a preferred embodiment of the invention step b) further includes the identification of changes in the collected image compared with an earlier collected image of the same waste pit, prior to the identification of the individual object.

The comparison of two images of the same waste pit collected at different points in time enables a very fast and accurate identification of changes in the waste pit. These changes can be used to detect if a truck has arrived and delivers new waste. These changes can also refer to newly delivered waste objects in the waste pit or objects changing position within the waste pit-for example when the crane has shifted objects from one place in the waste pit to another place. This additional comparison step is particularly useful if a lot of waste is delivered to the waste pit at the same time and piles of new waste are formed, such that not every newly delivered object is visible from the surface.

In the above embodiment, it is preferred that the time difference between two collected images is lower than the feeding rate of the waste pit.

In other words, if the waste pit is fed with waste delivered by trucks and these trucks deliver waste every 3 minutes, the time difference between two images is preferably lower than 3 minutes. With the time difference between two images being lower than the feeding rate or being equal to the feeding rate of the waste pit, it is ensured that every new batch of waste delivered to the waste pit is scanned for bulky waste objects.

In general, the time difference between two images are preferably lower than 1 minute, most preferably an image is collected every second to ensure that every newly provided waste in the waste pit is detected and if detection while falling is desired.

In a preferred embodiment of the invention, a series of images is collected when a waste truck arrives and unloads waste into the waste pit. This allows to obtain an image or images of the waste in the motion of falling into the waste pit.

Preferably the image is cropped to an area, in which the changes have been detected. The term “cropped” in the context of this invention is used to describe the reduction of the geometrical size (height and width) of an image. By cropping the size of the image to the area where change is detected, the further processing of steps c) and d) can be performed much quicker.

In a preferred embodiment of the invention, the collected image of step a) is modified using an algorithm for projective transformation before step b)—the identification of individual objects—is executed. This modification is used to ensure that each pixel in the resulting projected image corresponds to a fixed measurement length (for example each pixel represents a length of 1 cm). This modification has the advantage that the size estimation can be simplified.

There are various ways to segment an image. Some of the main techniques include semantic segmentation, instance segmentation and panoptic segmentation. Common image segmentation techniques known in the art are edge-based segmentation, threshold-based segmentation, region-based segmentation, cluster-based segmentation, and watershed segmentation.

In a preferred embodiment of step b) the algorithm for segmentation is a graph-based segmentation algorithm, in particular a Felzenszwalb algorithm (also known as Felzenszwalb-Huttenlocher algorithm) or an edge detection algorithm. Edge-based segmentation algorithms identify edges based on contrast, texture, color, and saturation variations. They can accurately represent the borders of objects in an image using edge chains comprising the individual edges.

For the inventive method the Felzenszwalb algorithm is particularly preferred as it was found to be superior compared to other segmentation algorithms from the cluster or threshold family, since the Felzenszwalb algorithm is much faster than other Segmentation algorithms for the task of segmenting objects. A threshold segmenting algorithm only uses two classes (0 or 1) and is therefore less efficient in distinguishing the border between objects. A clustering segmenting algorithm on the other hand only clusters segments with the same colors, which is not suitable for size detection.

Preferably an unsupervised algorithm for segmentation is used. The term “unsupervised algorithm” in the context of this invention is used to describe an algorithm that does not require training samples to perform its task. In contrast thereto, a supervised algorithm would require segmented images as training samples. The benefit of using an unsupervised algorithm is that the time-consuming task of labeling training samples can be avoided.

In a preferred embodiment of the invention the size determination of the identified individual object in step c) involves fitting an ellipsis to the segment of the identified individual object and then determining the centroid and the respective length of a major axis and of a minor axis of the ellipsis. A major axis in this context is the longest diameter of the ellipsis and the minor axis is the shortest diameter of the ellipsis. To determine the centroid, major axis, and minor axis of an individual object the scikit-learn library in python can be used.

It has surprisingly been found that the approach of estimating the size by using the centroid, the major axis and the minor axis is very efficient and precise.

Preferably the lengths of the major axis and minor axis of the ellipsis are each compared in step d) with a separate threshold value.

In another preferred embodiment of the invention the size determination of the identified individual object in step c) involves determining the length of the longest straight line between two points of the segment line.

In the context of the invention the term “segment line” refers to the perimeter of a segment or object. The longest straight line therefore refers to the longest distance (straight line) between two points on the segment line.

Preferably said length of the longest straight line is compared in step d) with a threshold value.

Both preferred approaches mentioned above, i.e. the comparison of the length of the major axis and minor axis of the ellipsis and the comparison the length the longest straight line between two points of the segment line with a threshold value have been found to provide a good balance of accuracy versus complexity of the object detection. In particular, these 2D approaches proved to be more useful than a more accurate 3D approach using 3 perpendicular axes, which was found to be much more difficult to calculate and required more expensive hardware.

In a preferred embodiment of the invention the classification step e) is executed using a logistic regression model trained with a combination of the features of area, ratio of area over length of the perimeter and/or the shape index of the individual object to predict whether a segment corresponds to a bulky waste object or not.

Preferably the combination of features includes either the area and the ratio of area over length of the perimeter, or the area and the shape index, or the ratio of area over length of the perimeter and the shape index. More preferably the combination of features includes the area, the ratio of area over length of the perimeter and the shape index.

It has surprisingly been found that the use of the above-mentioned logistic regression model is a very accurate method to classify whether an object is a bulky waste object or not. For example, to execute the classification step e), a previously trained logistic regression model uses the bulky object identified previously in step d) as input to classify whether the bulky object is a bulky waste object or not.

Ways to calculate the area, ratio of area over length of the perimeter and/or the shape index as defined above are known to the skilled person.

Preferably area of the individual object is calculated by using the function “skiamge.measure.regionprops()” implemented in the python library “scikit-image”.

Preferably ratio of area over length of the perimeter of the individual object is calculated by dividing the area through the length of the perimeter values calculated using the function “skiamge. measure. regionprops ()” implemented in the python library “scikit-image”.

Preferably shape index of the individual object is calculated using the function “shape index” implemented in the python library “scikit-image”. The shape index is a single valued measure of local curvature, derived from the eigenvalues of the Hessian matrix, defined by Koenderink & van Doorn.

In another preferred embodiment of the invention the classification step e) is executed using a convolutional neural network (CNN) to classify whether an object is a bulky waste object or not. It has surprisingly been found that a CNN provides a very accurate classification of bulky waste objects. In particular, the usage of a trained CNN has the advantage that that CNNs have the ability to find underlying features during the training process, which removes the need of feature engineering.

Preferably the CNN is trained with a training dataset comprising images of waste and non-waste objects prior to its usage in the classification step e). For example, the training dataset comprises labeled images of typical non-waste objects that are present in the waste pit such as the crane, the gates, and the side walls, in addition to labeled images of typical waste objects such as mattresses, metal pipes, supermarket shopping trolleys, palm tree trunks or rubbish bins.

In a preferred embodiment of the invention the image in step a) is collected with an RGB camera.

In a preferred embodiment of the invention the image of step a) is collected while the waste is falling into the waste pit. This has the advantage that the individual objects can be distinguished more easily from each other in the motion of falling compared to when they are stored as a pile of waste in the waste pit.

In a preferred embodiment of the invention, step c) further includes the identification of the type of material of the individual object by using an identification algorithm, which has been trained with a training dataset comprising labeled waste type material.

The advantage of further identifying the type of material of the individual object is that a waste pit not only comprises waste objects that are too bulky to be incinerated but also objects produced from a material or comprising a material that cannot be or should not be incinerated, for example metal pipes or gas bottles. If these objects are small or can be broken into smaller parts, they would not be classified as bulky waste objects. Nonetheless, such objects should not be incinerated, since they are not combustible.

Another aspect of the invention refers to a device for object detection based on size in the waste pit of a waste treatment plant comprising a camera, a data processing unit, an image collection unit, an individual object identification unit, a size determination unit and a classification unit. The image collection unit is adapted to collect an image of waste in a waste pit of a waste treatment plant. The individual object identification unit is adapted to identify individual objects in the image using an algorithm for segmentation. The size determination unit is adapted to determine the size of the identified individual object and the classification unit is adapted to compare the size of the identified individual object with a threshold value and classifying whether the object is a bulky waste object or not.

As described above in connection with the inventive method, the device for object detection based on size in the waste pit of a waste treatment plant allows a determination of the object size independent of the object type or material. In other words, the inventive device does not aim at identifying the type or nature of a waste object (e. g. “chair”, “mattress”, “plastic box” or “piece of wood”) but merely aims to determine whether its size is above or below a given threshold value. This reduction of information enables the device to carry out an efficient approach to identify bulky waste objects. It is therefore also no problem to identify bulky waste objects with the device according to the present invention if a waste object is broken or if there is only part of a specific object left, as long as the visible part or the broken piece is still above the plant waste-size limits defined by the threshold value.

Preferably the device uses an unsupervised algorithm for segmentation. This has the advantage that the time-consuming preparation of a database for training is not required.

The present invention will now be described, by way of a non-limiting example:

In a waste pit of a waste treatment plant an image I₀ of the waste is collected by a camera at a time point T₀. Said image I₀ may include a series of images. The image I₀ is transferred to a data processing unit, here a computer, and stored. After the image Io is collected, a truck delivers new waste to the waste pit and unloads the waste through openings (gates) in the walls of the waste pit. After the batch of new waste was delivered a new image I1 of the waste is collected at time point T₁ and transferred to the data processing unit. The time elapsed between time point T₀ and T₁ is preferably synchronized with the frequency of the delivery of new waste. This means that after every new delivered batch of waste, a new image is collected. It is therefore possible that the time interval between two images is variable. As an alternative, images can be collected with a fixed time interval in between. The variable time interval between images could be achieved for example with the aid of a sensor that detects when new waste is delivered. This sensor could be the afore-mentioned camera, another camera or a motion detection sensor that detects when a truck is arriving. When the sensor detects such an arriving truck, every image collected afterwards is marked with a label for further processing (e.g. with the label “new waste delivered” or “relevant”). When the sensor detects that the truck has left, all afterwards collected images will not be marked with a label until the sensor detects the next arriving truck. That data processing unit only stores images that were marked as relevant, here with the label for further processing. This reduces the computing time and saves memory space. It is also possible that a series of new images is collected while the new waste is delivered. In this case the sensor activates the camera to capture a series of new images until the sensor is deactivated when the truck is leaving. This series of images comprises a multitude of images each with an individual time stamp and captures the objects (waste object) in the process of falling from the truck into the waste pit. This is preferable since a load of new waste can form a pile in the waste pit and bulky objects may not be detected if they are on the ground and covered by other newly delivered waste objects. A series of images with an individual time stamp also ensures that all bulky waste objects are detected in case there is more than one bulky waste object per truck. Hence the collection of a series of new images can help to detect objects that are later covered by other waste objects delivered by the same truck or in the same batch.

In case the above-mentioned sensor is installed changes in the image can be detected according to the following non-limiting example:

Each newly collected image I_{X} is compared with the previous image I_{X-1} and differences in the images are detected. To detect such differences the image is first converted to grayscale and an area of interest mask is applied. For example, if a camera is facing the delivery gates of the waste pit, an area of interest mask that has polygons matching the shape of each visible gate is applied. Such a mask sets all pixel outside of the polygons—outside of the gates—to black. Therefore, in an image in which the area of interest mask is applied only the pixels related to the specific area—here the gates—contain visible content.

After this preprocessing is done for both images, the images I_{X} and I_{X-1} are compared on a pixel level, which means that the data processing unit uses an algorithm that compares every pixel of image I_{X} with the corresponding pixel of image I_{X-1} and pixels with no difference in the image I_{X} and I_{X-1} are excluded—changed to black—to create a new image I_{ΔX}. This process is also called image differentiation.

An erosion filter is applied to the image I_{ΔX} to eliminate any remaining background noise, thus creating an image I_{ΔXeroded}. For the image I_{ΔXeroded} a motion detector parameter is determined by calculating the standard deviation of the pixel values in the image I_{ΔXeroded}. If the motion detector parameter is equal or below a threshold value, the image I_{ΔXeroded} is not further analyzed, since it is estimated that no motion was detected. If the motion detector parameter is above the threshold value, the image I_{X} is further analyzed to detect if a bulky waste object was delivered to the waste pit.

The image I_{X} is further modified by a protective transformation, commonly known as homography. In a protective transformation a region originating from a plane (here the gates) within the image I_{X} is projected in an image I_{X-PT} such that each pixel in the resulting image I_{X-PT} corresponds to a measurement of a fixed distance—here 1 cm—to allow size estimation.

The image I_{X-PT} is further processed using Felzenszwalb's algorithm for segmentation. The Felzenszwalb algorithm is a graph based algortihm for segmenting an image into objects. The algorithm first places an edge between each two adjacent pixels of an image, which are weighted according to features such as the difference in brightness and color of each adjacent pixel. Then, image segments are formed from each pixel, which are merged in such a way that the difference between the edge weights within a segment remains as small as possible and becomes as large as possible between adjacent segments.

The identified segments (objects) are then treated as individual candidates for bulky waste objects in the waste pit. Each object is labeled with a tag comprising a unique identifier.

For each identified individual object an ellipsis is fitted to the object and the centroid, length of the major axis and length of the minor axis are determined. The respective length of the major axis and minor axis are each compared with a separate threshold value. If the lengths of the major axis and minor axis are above the threshold value, the object is viewed as a bulky object and is further analyzed based on its geometrical properties.

For each identified individual bulky object, the following geometrical features are determined: area of the object, ratio of area of the object over length of the perimeter of the object and shape index of the object. These features are then implemented into a trained logistic regression model to obtain a classification whether the object is a bulky waste object or not.

1. Method for object detection based on size in the waste pit of a waste treatment plant comprising the steps of:
a) Collecting an image of waste in a waste pit of a waste treatment plant using a camera and transferring the image to a data processing unit;
b) Identifying an individual object in the image using an unsupervised algorithm for segmentation;
c) Determining the size of the identified individual object;
d) Comparing the size of the identified individual object with a threshold value; and
e) Classifying whether the object is a bulky waste object or not
wherein the size determination in step c) involves fitting an ellipsis to the segment of the identified individual object and further determining the centroid and the respective lengths of a major axis and a minor axis of the ellipsis, or
wherein the size determination in step c) involves calculating the longest straight line between two points on a segment line of the object.

2. Method according to claim 1, wherein the algorithm for segmentation of step b) is a Felzenszwalb algorithm or an edge detection algorithm.

3. (canceled)

4. (canceled)

5. Method according to claim 1, wherein in step d) the lengths of the major axis and the minor axis are each compared with a separate threshold value.

6. (canceled)

7. Method according to claim 1, wherein the classification step e) is executed using a logistic regression model trained with the features of area, ratio of area over length of the perimeter and/or the shape index to classify whether an object is a bulky waste object or not.

8. Method according to claim 1, wherein the classification step e) is executed using a convolutional neural network to classify whether an object is a bulky waste object or not.

9. Method according to claim 1, wherein the image of step a) is collected with an RGB camera.

10. Method according to claim 1, wherein the image of step a) is collected while the waste is falling into the waste pit.

11. (canceled)
